(19) United States
(12) Patent Application Publication
(10) Pub. No.: US 2026/0131491 A1
(43) Pub. Date: May 14, 2026

(54) SWITCH GROUP WITH PROTECTIVE COVERING FOR AN ELECTRIC HAIR CLIPPER

(71) Applicant: GAMMA PIU' S.R.L., Cazzago San Martino (Brescia) (IT)

(72) Inventor: Paolo STERZI, Cazzago San Martino (Brescia) (IT)

(21) Appl. No.: 19/077,421

(22) Filed: Mar. 12, 2025

(30) Foreign Application Priority Data
Nov. 13, 2024 (IT) 102024000025575

(51) Int. Cl. B26B 19/28; B26B 19/38

(52) U.S. Cl. CPC B26B 19/28; B26B 19/3853

(57) ABSTRACT

A switch group for powering an electric hair clipper has a box-shaped housing in which a chamber is defined. A lever group arranged at least partially in the chamber is provided with an actuating knob protruding from an opening of the box-shaped housing. The switch group has a covering, in a form of a flexible membrane applied to an upper wall of the box-shaped housing to close the opening. The covering has a lever hole crossed by the actuating knob and adheres to the actuating knob to prevent infiltration of dirt, dust and hair, inside the box-shaped housing.

### CROSS-REFERENCE TO RELATED APPLICATION

This application claims priority to Italian Patent Application No. 102024000025575 filed Nov. 13, 2024, the entire contents of which is hereby incorporated in its entirety by reference.

### FIELD OF THE INVENTION

The present invention relates to a power switch group, of the lever type, for an electric hair clipper and more generally for electric machines for cutting beards and hair.

### BACKGROUND OF THE INVENTION

In the field of devices for cutting hair or beards, electric machines are known which are provided with toothed metal blades, called combs and counter-combs, mounted parallel to each other and capable of moving relatively so that the contrast between the two toothings results in cutting the hair. An example of such devices is described in prior art document U.S. pat. No. 3,589,007A. These machines are equipped with a lever-shaped power switch, of the ON/OFF type, suitable to switch the hair clippers on and off according to the needs of the user. A well-known problem is that of dirt, such as dust and fragments of hair, which accumulates at the switch lever. Although the hair clipper instruction manual requires the area surrounding the switch lever to be thoroughly cleaned, for example by a small brush, dust and hair may still infiltrate inside the switch itself and, over time, prevent its correct operation. In such cases it is necessary to open the switch for internal cleaning thereof or, in the worst cases, it is inevitable to proceed with the complete replacement of the switch.

In the field of electric hair clippers, there is therefore a need for a power switch, of the lever type, which is not affected by the problems of the prior art, and in particular which is not at risk of infiltration of dirt, i.e. dust and hair, therein.

### SUMMARY OF THE INVENTION

Such object is achieved by a switch group as described and claimed herein. Preferred embodiments of the present invention are also described.

### BRIEF DESCRIPTION OF THE FIGURES

Further features and advantages of the switch group according to the present invention will appear more clearly from the following description, given as a non-limiting example according to the accompanying figures, in which:

FIG. 1 is a top view of an electric hair clipper equipped with a power switch group according to the present invention;

FIG. 2 is an axonometric view of a power switch group according to the present invention;

FIG. 3 shows the switch group of FIG. 2 in a partially exploded view;

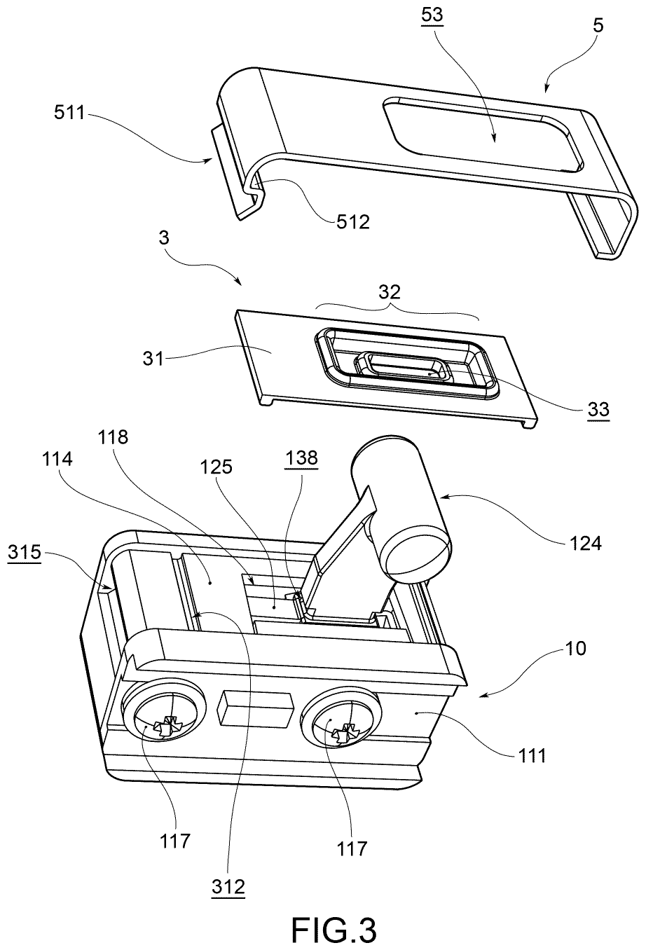

FIG. 4 shows the switch group of FIG. 3 in which a side portion of the housing has been removed to show the internal structure thereof;

FIG. 5 shows the switch group of FIG. 2 in a side view in which a side portion of the housing has been removed to show the internal structure thereof; and

FIGS. 6a through 6c are, respectively, an axonometric view from above, an axonometric view from below, and a top view of a component of the switch group of FIG. 2.

### DETAILED DESCRIPTION

With reference to the accompanying figures, reference numeral 1 has been used to indicate as a whole a switch group, of the lever type, according to the present invention, for powering an electric hair clipper 9, and more generally for electric shaving and hair cutting machines.

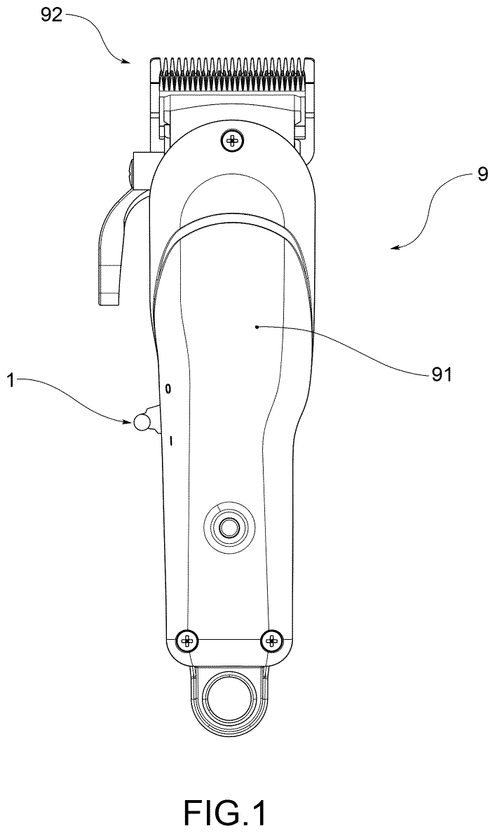

An electric hair clipper 9, as shown for example in FIG. 1, comprises a shell 91 in which a switch group 1 is housed, suitable to switch a blade assembly 92 on and off. The blade assembly 92 comprises, for example, toothed metal blades, called combs and counter-combs, mounted parallel to each other and capable of moving relatively so that the contrast between the two toothings results in cutting the hair.

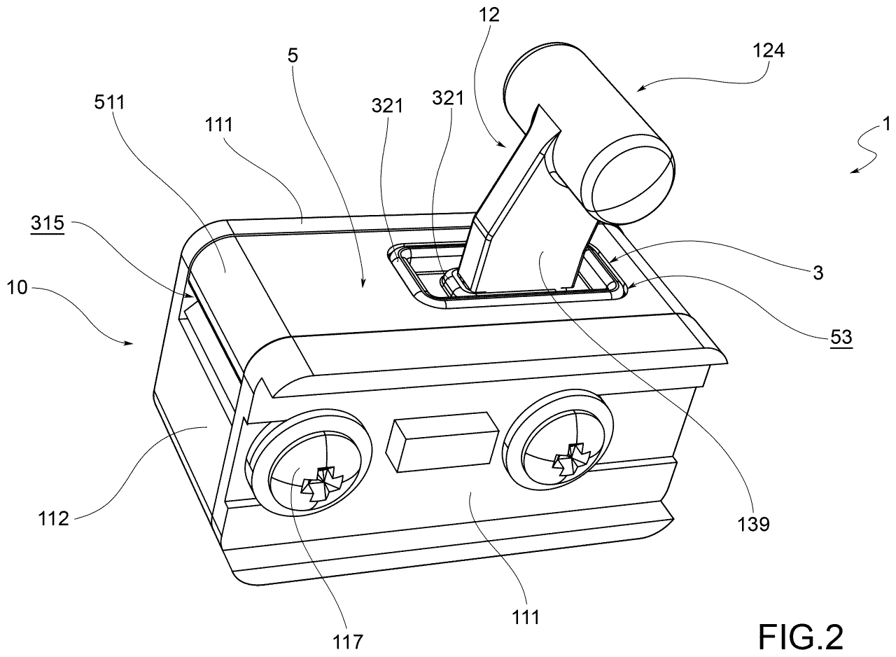

As shown in FIG. 2, the switch group 1 comprises a box-shaped housing 10 in which a lever group 12 is housed. Preferably, the housing 10 is made of a plastic material.

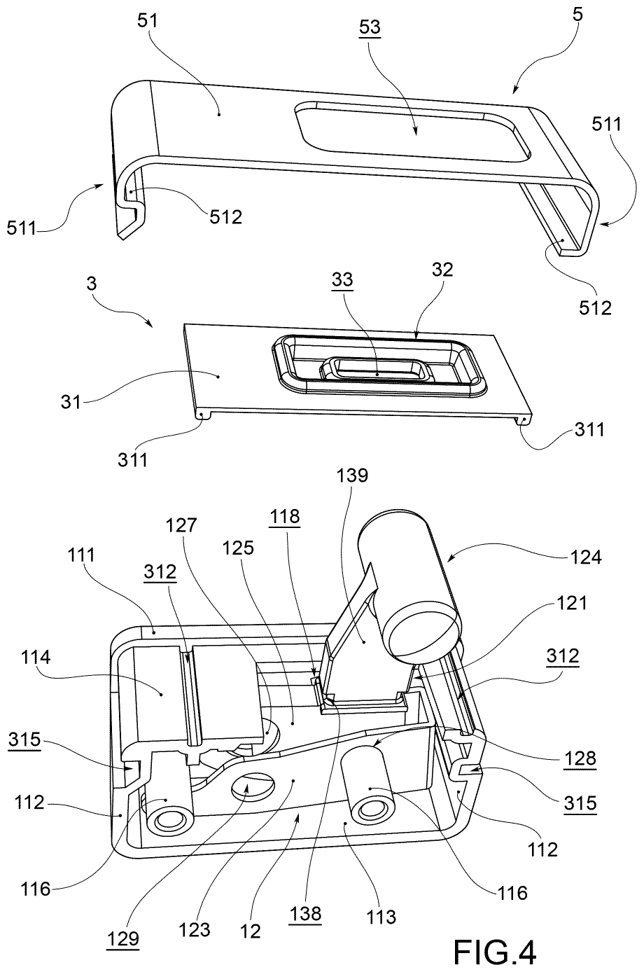

The housing 10 comprises a lower wall 113, an upper wall 114, and four vertical walls, preferably two long walls 111 and two short walls 112. The housing 10 defines therein, between the walls 111-114, a chamber 115 in which a lever group 12 is housed. Preferably, as shown for example in FIG. 4, the lower wall 113, the upper wall 114, the two short walls 112, and a long wall 111 are made in one piece, i.e. they form a single piece, and another long wall 111 may be removed to form a closing cover of the housing 10.

At least one support 116 is provided inside the chamber 115, suitable to allow proper fixing in position of the lever group 12 and/or the long wall 111, which forms the closing cover of the housing 10.

The support 116 may be, for example, a cylinder protruding inside a long wall 111, provided with an internal thread for a screw 117. Preferably, two aligned supports 116 protrude from the long wall 111, each suitable to house a screw 117.

The upper wall 114 of the housing 10 is provided with an opening 118 from which a part of the lever group 12 protrudes, and in particular an actuating knob 124.

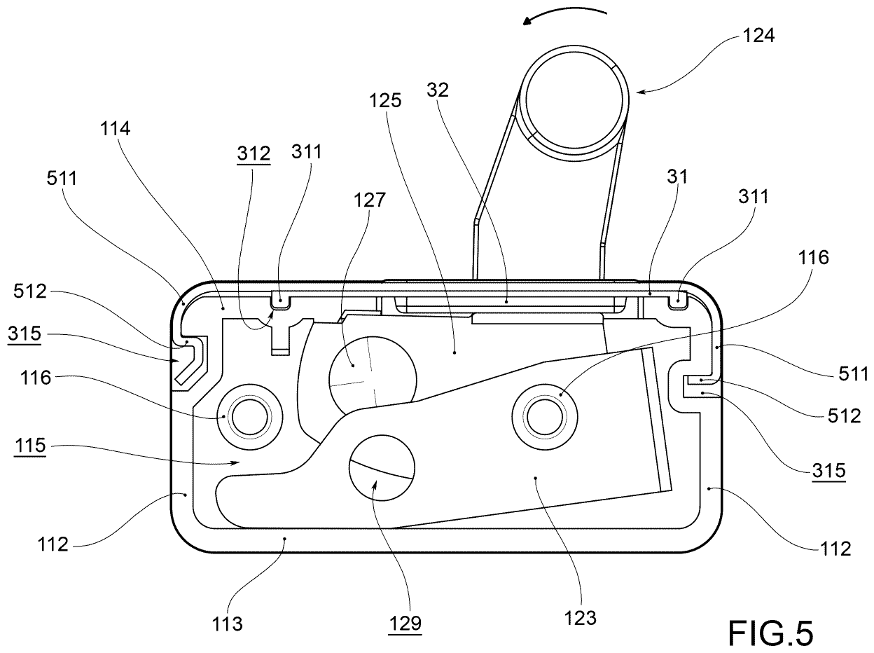

An exemplary lever group, as shown in FIGS. 4 and 5, will now be described; however, the present invention is applicable also to a switch group 1 containing a different type of lever group, as long as it is provided with an actuating knob. The lever group 12 comprises a lever 121, made of a plastic material, connected to a metal band 123. The lever 121 comprises an actuating knob 124 integral with a lever body 125 provided with a lever hole, for fixing it into position in the housing 10, and a metal ball 127, suitable to make electrical contact with the metal band 123.

The metal band 123, in the shape of a fork or U, is provided with at least one bar hole 128 for fixing it into position in the housing 10, and at least one contact hole 129 for correct contact positioning of the metal ball 127. As may be seen in FIGS. 4 and 5, the lever 121 is pivoted to the support 116 of the housing 10 by the lever hole of the lever body 125, and, by acting on the actuating knob 124, may translate longitudinally to assume an OFF position, as in FIG. 5 in which the metal ball 127 is not at the contact hole 129, and an ON position, in which the metal ball 127 is at the contact hole 129. The metal band 123 is also pivoted to the support 116 of the housing 10 by means of the bar hole 128.

Advantageously, the switch group 1 according to the present invention is provided with a flexible covering 3 for closing the opening 118 in the upper wall 114 of the housing 10 in order to prevent entry of dust, hair fragments, and other impurities inside the chamber 115 in which the lever group 12 is housed. The covering 3 is substantially a soft plastic membrane, for example made of silicone or similar materials, which prevents any type of dust or small hairs from entering.

Preferably, the covering 3 extends to also at least partially cover the upper wall 114, and in particular a contour of the opening 118.

The covering 3 is substantially a flexible sheet provided, substantially centrally, with a lever hole 33 for the passage of the actuating knob 124 of the lever group 12. The opening defined by the lever hole 33 is dimensioned either to correspond to or to be slightly undersized with respect to the cross section of the actuating knob 124 to allow proper adhesion of the covering 3 to the knob and thus prevent dirt from infiltrating through the lever hole 33.

The covering 3 is provided with a base body 31, which defines a covering plane, suitable to be positioned above the upper wall 114. The covering 3 is provided, substantially centrally, with a deformable zone 32 which is positioned above the opening 118 and provided with the lever hole 33.

The deformable zone 32 is formed of offset portions 321, which are mutually concentric and arranged on different planes. The offset portions 321 form accumulations of material that increase the elasticity of the covering 3 at the deformable zone 32 so that it may easily deform to follow the movement of the actuating knob 124 and ensure proper adhesion of the covering 3 to the knob and thus prevent dirt from infiltrating through the lever hole 33.

Preferably, the offset portions 321 are arranged on planes other than the covering plane defined by the base body 31 of the covering 3, i.e., they protrude or retract therefrom.

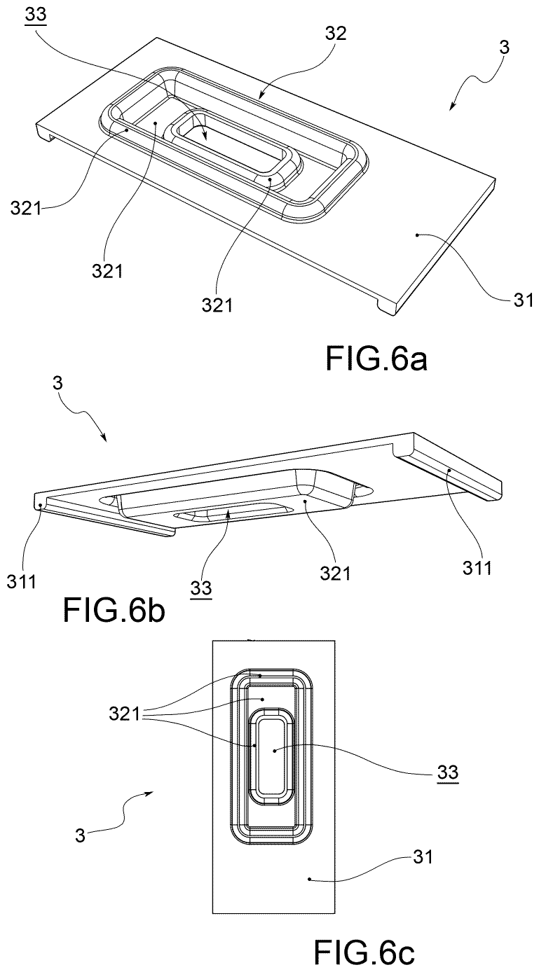

Preferably, as shown in FIG. 6a, the deformable zone 32 comprises a peripheral offset portion 321, arranged on an upper, i.e., protruding, plane with respect to the covering plane defined by the base body 31 of the covering 3.

Preferably, as shown in FIG. 6a, the deformable zone 32 comprises an intermediate offset portion 321, arranged on a lower, i.e., recessed, plane with respect to the covering plane.

Preferably, as shown in FIG. 6a, the deformable zone 32 comprises a central offset portion 321, arranged on an upper, i.e., protruding, plane with respect to the intermediate offset portion 321.

The covering 3 assumes the function of a bellows seal closing the space between the opening 118 in the upper wall 114 of the housing 10 and the actuating knob 124 of the lever group 12 and thus preventing dirt from infiltrating through the lever hole 33. Advantageously, therefore, the covering 3 has a bellows-type movement: it always follows the actuating knob 124 when the actuating knob is actuated, closing in every position any small gap that may exist between the lever and the housing.

Preferably, the covering 3 is provided with stop means, for example in the form of ribs 311 suitable to be inserted into appropriate grooves 312 made in the upper wall 114 of the housing 10, as shown in FIG. 5. Preferably, as shown in FIG. 6b, the covering 3 is provided with two transverse ribs protruding below the base body 31, preferably at the transverse ends.

In an alternative variant, the covering 3 is glued, welded, or otherwise fixed to the housing 10.

The covering 3, being a soft and flexible membrane, is fitted onto the actuating knob 124 and fixed in position onto the housing 10 by a plate 5. Preferably, the covering 3 is held in place on the housing 10 by a rigid plate 5, for example a metal plate, which is configured as a closing wall of the elastic spring type.

The plate 5 is substantially a rigid sheet provided, substantially centrally, with a covering hole 53 for the passage of the actuating knob 124 of the lever group 12. The opening defined by the covering hole 53 is preferably dimensioned to correspond to the outer perimeter of the deformable zone 32 of the covering 3 to allow the covering to deform and adhere correctly to the actuating knob 124, preventing dirt from infiltrating through the lever hole 33.

Preferably, to improve the sealing of the lever hole 33, the actuating knob 124 of the lever group 12 is provided, at a stem portion 139, with a seat 138, preferably recessed, suitable to at least partially house the innermost offset portion 321 of the deformable zone 32 of the covering 3 (namely the central offset portion).

The plate 5 is provided with a base portion 51, which defines a plate plane, suitable to be positioned above the upper wall 114 of the housing 10, covering the base body 31 of the covering 3.

When the plate 5 is in position on the housing 10, the deformable zone 32 of the covering 3 is arranged inside the covering hole 53. Preferably, the outermost offset portion 321 of the deformable zone 32 of the covering 3 (namely the peripheral offset portion) adheres to the perimeter of the covering hole 53 to prevent infiltration of dirt therethrough. Preferably, the outermost offset portion 321 of the deformable zone 32 of the covering 3 (the peripheral offset portion) is arranged on an upper plane, i.e., protruding, with respect to the plate plane defined by the base portion 51 of the plate.

The plate 5 is provided with fastening means, for example in the form of flexible legs 511 with abutment portions 512 suitable to be inserted (e.g., snapped) into specific cavities 315 preferably made in the short walls 112 of the housing 10, as shown in FIG. 4. Preferably, as may be seen in FIG. 4, the plate 5 is provided with two flexible legs 511 protruding below the base portion 51, preferably at the transverse ends.

In a different exemplary embodiment, the fastening means of the plate 5 are flexible legs 511 provided with holes for inserting appropriate fastening screws, intended to screw into the walls of the housing 10.

The plate 5 assumes the function of a locking element in the position of the covering 2, closing the space between the opening 118 in the upper wall 114 of the housing 10 and the actuating knob 124 of the lever group 12.

Innovatively, the switch group according to the present invention, being provided with a closing covering of the space between the housing 10 and the actuating knob 124, is not at risk of infiltration of dirt, i.e. dust and hair, therein.

Advantageously, the covering 3 assumes the function of a bellows seal closing the space between the opening 118 in the upper wall 114 of the housing 10 and the actuating knob 124 of the lever group 12, thus preventing dirt from infiltrating through the lever hole 33.

Advantageously, the switch group according to the present invention, being provided with a protective covering, does not require accurate cleaning operations in the area surrounding the switch lever. In addition, the switch is very reliable in terms of operation as dust and hair may not infiltrate the switch. Furthermore, this switch has a low risk of malfunctions and breakages due to dirt infiltration.

It is clear that a person skilled in the art may make changes to the invention described above in order to meet contingent needs, which changes all fall within the scope of protection as described and claimed herein.

What is claimed is:

1. A switch group for powering an electric hair clipper, comprising:
a box-shaped housing, in which a chamber is defined, and provided with an upper wall having an opening; and
a lever group, arranged at least partially in the chamber, and provided with an actuating knob protruding at least partially from the opening;
wherein the switch group further comprises a covering, in a form of a flexible membrane, applied to the upper wall of the box-shaped housing to close the opening, the covering being provided with a lever hole crossed by the actuating knob of the lever group, the covering adhering to the actuating knob.

2. The switch group of claim 1, wherein the lever hole of the covering is dimensioned either to correspond to or be slightly undersized with respect to a cross-section of the actuating knob.

3. The switch group of claim 1, further comprising a rigid plate for fixing the covering to the box-shaped housing, the rigid plate being provided with a covering hole crossed by the actuating knob of the lever group.

4. The switch group of claim 3, wherein the rigid plate is provided with flexible legs with abutment portions suitable for snapping into cavities made in walls of the box-shaped housing.

5. The switch group of claim 1, wherein the covering is provided with
a base body which defines a covering plane and which is positioned above the upper wall, and
a deformable zone, provided with the lever hole, which is positioned to close the opening of the upper wall, the deformable zone being formed by offset portions, mutually concentric and arranged on different planes.

6. The switch group of claim 5, wherein the offset portions are arranged on planes other than the covering plane defined by the base body.

7. The switch group of claim 5,
wherein the actuating knob of the lever group is provided, at a stem portion, with a seat in which a central offset portion of the deformable zone of the covering is at least partially housed,
wherein the central offset portion is arranged, on one side, adjacent to the lever hole, and on an opposite side, adjacent to an intermediate offset portion, and
wherein the central offset portion protrudes with respect to a plane defined by the intermediate offset portion.

8. The switch group of claim 5, wherein the switch group further comprises a rigid plate for fixing the covering to the box-shaped housing, the rigid plate being provided with a covering hole crossed by the actuating knob of the lever group, and
wherein the deformable zone comprises a peripheral offset portion which adheres to a periphery of the covering hole of the rigid plate, the peripheral offset portion
protruding with respect to the covering plane defined by the base body of the covering, and/or
protruding with respect to a plate plane defined by a base portion of the rigid plate.

9. The switch group of claim 1, wherein the covering is provided with ribs suitable for fitting into grooves made in the upper wall of the box-shaped housing.

10. The switch group of claim 1, wherein the lever group comprises:
a lever, made of a plastic material, formed by the actuating knob integral with a lever body provided with a metal ball; and
a metal band provided with at least one contact hole for electrical contact with the metal ball,
wherein the actuating knob is translatable between an OFF position, in which the metal ball is misaligned with respect to the contact hole, and an ON position, in which the metal ball is at the contact hole.

11. An electric hair clipper, comprising a shell supporting a blade assembly in which the switch group of claim 1 is accommodated, wherein the switch group is suitable for turning the blade assembly on and off.
